(19) United States
(12) Patent Application Publication
(10) Pub. No.: US 2025/0380695 A1
(43) Pub. Date: Dec. 18, 2025

(54) INSECTICIDE FORMULATIONS WITH BUILT-IN ADJUVANTS

(71) Applicant: ADAMA MAKHTESHIM LTD., Beer Sheva (IL)

(72) Inventors: Arunagirinathan Manickam ADHIMOOLAM, Ramapuram Chennai (IN); Vilas Patil BHAGAWAN, Kolhapur (IN); Venkateswararao YADAGANI, Hyderabad (IN)

(73) Assignee: ADAMA MAKHTESHIM LTD., Beer Sheva (IL)

(21) Appl. No.: 18/879,103

(22) PCT Filed: Jun. 28, 2023
(86) PCT No.: PCT/IL2023/050663

§ 371 Date: Dec. 26, 2024

(30) Foreign Application Priority Data
Jun. 30, 2022 (IN) 202211037706

(51) Int. Cl. A01N 43/38; A01N 25/04; A01N 25/22; A01N 47/30; A01P 7/04

(52) U.S. Cl. CPC A01N 43/38; A01N 25/04; A01N 25/22; A01N 47/30; A01P 7/04

(57) ABSTRACT

The present invention provides an agrochemical suspension in concentrate form, comprising at least one ketoenol insecticide; a certain amount of at least one adjuvant; at least one steric and/or static stabilizer; at least one rheomodifier; and water.

### TECHNOLOGICAL FIELD

The present disclosure concerns insecticide formulations, more specifically insecticide formulations that comprise adjuvants and are stable in concentrated form.

### BACKGROUND

Utilization of various insecticides to reduce infestation by insects on commercially grown agricultural crops has been carried out for many years. Various insecticides are known, and can be used on their own or in combination with one or more adjuvants in order to increase their efficiency.

Combining the insecticide active components and the adjuvants into water or other carrier liquid is typically made in the field shortly or immediately before use (what is known as “tank mix”), as stock formulations that include both the insecticides and the adjuvants are known to be physically unstable (e.g. characterized by phase separation). Such physical instability has an impact on the ability to control the concentrations of the active components that are added from the stock formulation to the water, which may result in under- or over-application of the insecticides. Further, such stock formulations are known to have relatively high viscosity, impeding manufacturing and packaging processes, as well as makes such stock formulations difficult to dose and apply in the field.

### GENERAL DESCRIPTION

The present disclosure concerns stock (i.e. concentrated) formulations of insecticides and adjuvants that are stable in concentrated form for a prolonged period of time, as well as having a suitable viscosity for in-situ dilution prior to application in the field. The inventors have surprisingly found that combination of insecticides, adjuvants and carefully selected steric and/or static stabilizers results in a concentrate formulation that is physically and chemically stable, permitting its long-term storage, while also obtaining sufficiently low viscosity as to obtain a readily-dilutable formulation prior to use.

Thus, according to an aspect of the present disclosure, there is provided an agrochemical suspension in concentrate form, comprising:
a) at least one ketoenol insecticide;
b) from about 2 wt % to about 20 wt % of at least one adjuvant;
c) at least one steric and/or static stabilizer;
d) at least one rheomodifier; and
e) water.

The suspension formulations of this disclosure provide for long-term stability under storage conditions as a concentrated form, readily dilutable prior to use. The unique combination of physical and chemical interactions between the formulations' components permits stabilization of the formulation against phase separation, as well as providing reduced viscosity for accuracy and ease of application.

The formulations are in concentrate form, namely formulations having a concentration of active components which is higher than the concentration to be applied onto the crop. Unlike ready mixes, which are pre-diluted forms formulations or tank mixes (which are mixtures prepared in situ immediately before application by simple mixing of ingredients into the application vessel), the formulations of this disclosure are designed to maintain their physical stability for long-term storage conditions and are readily dilutable prior to application.

The formulations are in suspension form, i.e. a liquid formulation comprising droplets or particles that are substantially homogeneously dispersed within a continuous liquid phase.

The term insecticide or insecticidal refers to components having an activity of reducing or eliminating animal pests, typically insect populations, in agricultural or horticultural crops. The term includes insecticides that have insect killing activity of various insect types and at various stages of development of the insect, e.g. eggs, larva, pupa, nymphs and adults.

The suspension comprises at least one ketoenol insecticide. Ketoenols are compounds that exbibit Keto-Enol tautomerism, in which the compound exists in chemical equilibrium between the keto form (carbonyl structure containing α-hydrogen) and the enol form (a double bond adjacent to an alcohol, —C═C—OH) of a compound.

According to some embodiments, the at least one ketoenol insecticide is selected from spirotetramat, spidoxamat, spiropidion, spirodiclofen, spiromesifen, and combinations thereof.

By some embodiments, the at least one ketoenol insecticide is Spirotetramat.

Spirotetramat is known to have activity mainly against piercing-sucking insects, such as aphids, mites, and white flies, by acting as an ACC inhibitor, interrupting lipid biosynthesis in the insects. Spirotetramat, or 3-(2,5-Xylyl)-4-(ethoxycarbonyloxy)-8-methoxy-1-azaspiro[4.5]dec-3-en-2-one, exists in cis- and trans-forms, as shown in Formulae (I) and (II) respectively:

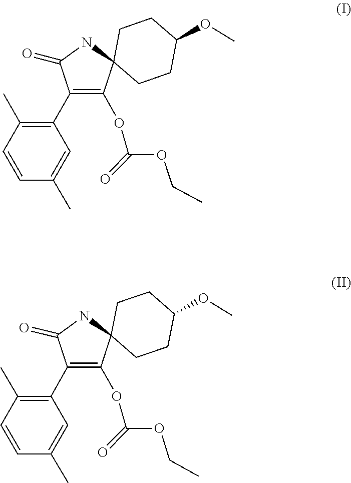

By some embodiments, said Spirotetramat is cis-Spirotetramat or in the form of its cis/trans isomeric mixture.

According to some embodiments, the concentration of said at least one ketoenol insecticide in the suspension is at least 2 wt %. By some other embodiments, the concentration of said at least one ketoenol insecticide in the suspension ranges between about 2 wt % and 30 wt %.

As noted, the inventors have found that when one or more ketoenol insecticides are combined with one or more adjuvants, an improved insecticidal activity can be obtained, compared to the utilization of the ketoenol insecticide without such adjuvant(s).

The term adjuvant means to denote a substance that does not, in itself, have pesticide activity, however, enhances the effectiveness of pesticides once combined therewith. In its broadest definition, an adjuvant can be a spreading agent, a penetrant, a compatibility agent and/or a drift retardant.

In suspensions of this disclosure, the at least one adjuvant is selected from C8-C16 fatty alcohol alkoxylates, which are prepared by alkoxylating fatty alcohols and/or fatty acids.

By some embodiments, the adjuvant is a C8-C16 fatty alcohol alkoxylate. According to some embodiments, the adjuvant is at least one linear branched C8-C10 alcohol ethoxylate, C8-C10 alcohol propoxylate, C9-C11 alcohol ethoxylate, C9-C11 alcohol propoxylate, C12-C15 alcohol ethoxylate, C12-C15 alcohol propoxylate, isodecyl alcohol ethoxylate, isodecyl alcohol propoxylate, isoundecyl alcohol ethoxylate, isoundecyl alcohol propoxylate, isotridecyl alcohol ethoxylate, isotridecyl alcohol propoxylate, and polyethylene glycol trimethylnonyl ether.

According to some other embodiments, the at least one adjuvant is selected from trimethyl nonyl ethoxylate (Tergitol TMN-6), C9/C11 alcohol ethoxylate/propoxylate (Atplus 245), and mixtures thereof.

According to some embodiments, the suspension comprises at least about 2 wt % of said adjuvant. By other embodiments, the concentration of said at least one adjuvant in the suspension ranges between about 2 wt % and about 20 wt %.

By some embodiments, the suspension comprises between about 5 wt % and about 8 wt % Tergitol TMN-6. By other embodiments, the suspension comprises between about 12 wt % and about 14 wt % Atplus 245.

As noted, most commercial formulations that include ketoenol insecticides and an adjuvant are not physically stable, and exhibit significant phase separation, making such unsuitable for long-term storage and accurate dosing. The inventors of the present invention have surprisingly found that incorporation of carefully selected steric and/or static stabilizers significantly improve the stability of the suspensions, minimizing or even preventing phase separation for a period of time of at least 1-year, rendering the formulations suitable for long-term storage, while also permitting increasing the concentration of the adjuvant(s) in the suspension (i.e. for up to about 20 wt % of adjuvant(s) in the suspension).

The term steric stabilizer means to denote a compound or a substance that stabilizers colloidal particles/droplets within a suspension or dispersion by creating a steric hindrance between the particles/droplets, thereby preventing coalescence and aggregation. In other words, the steric stabilizer inhibits coagulation and aggregation of suspensions or dispersions.

The term static stabilizer refers to a compound or a substance that generates surface charge and/or surface potential in aqueous suspensions, thereby preventing aggregation of the particles/droplets by induction of repulsive forces.

In the present disclosure, the steric stabilizer and/or static stabilizer are selected to physically and/or chemically interact with a component in the suspension, typically with the adjuvant(s), to obtain steric stabilization of the adjuvant within the suspension, and maintain the adjuvant in suspended (or dispersed) form. The steric and/or static stabilizers utilized in the suspensions of this disclosure are selected to have one or more hydrophobic moieties that are capable of physically interlocking with said at least one adjuvant, thereby stabilizing the adjuvant within the suspension and permitting high loads of the adjuvant into the suspension with minimal risk of phase separation. In other words, the steric and/or static stabilizer is selected to permit mechanical entanglement of the hydrophobic moieties thereof with the adjuvant, hence holding the adjuvant within the suspension. The steric and/or static stabilizers can be non-ionic, anionic, cationic, zwitterionic, or amphophilic.

By some embodiments, the at least one steric stabilizer is selected from ethyleneoxide/propyleneoxide copolymers, acrylate/methacrylate copolymers, C10-C14 fatty alcohol ethoxylates and any combination thereof.

By other embodiments, the static stabilizer is selected from alcohol sulphates, alcohol sulfonates, alkyl sulphates, aryl sulphates, alkylaryl sulphates, alkyl-ether sulphates, aryl sulphonates, alkyl aryl sulfonates, lignosulfonates, fatty acid sulfonates (e.g. laurylsulfonate), mono-, di- or tristyryl phenol ethoxylate sulphates, taurate (N-methyl oleyl taurate), isethionate (cocoyl isethionate), and combinations thereof.

According to some embodiments, the at least one steric and/or static stabilizer is selected from ammonium salts of ethoxylated tristyrylphenol sulphate (e.g. Tersperse 2218), isotridecyl alcohol ethoxylate (e.g. Alkont IT60), acrylic graft copolymer (e.g. Tersperse 2500), Ethoxylated Tristyrylphenol phosphate (e.g. Soprophor 3D 33R), polyalkylene oxide block copolymer (e.g. Atlas G5002L), and combinations thereof.

According to some embodiments, the total concentration of steric and/or static stabilizers in the suspension is between about 1 wt % and about 9 wt %.

According to some embodiments, the weight ratio (w/w) of said at least adjuvant to said steric and/or static stabilizer ranges between about 1:5 and about 5:1. The inventors have further found that incorporation of said at least one steric and/or static stabilizer into the concentrated suspension enables physically interlocking the adjuvant within the hydrophobic moieties of the steric and/or static stabilizer on the one hand, and controlling the viscosity of the suspension on the other by controlling the balance between the hydrogen bonds formed between the steric and/or static stabilizer hydrophilic moieties and the adjuvant, and a lubrication effect obtained by relative sliding of the steric and/or static stabilizer hydrophobic moieties.

Further control of the viscosity of the suspension is obtained by adding at least one rheology modifier to the suspension. The term rheology modifier (or rheomodifier) means to denote a compound or a substance that is capable of modifying, e.g. increasing or decreasing, the viscosity of the suspension.

According to some embodiments, the at least one rheology modifier is selected from polysaccharides, silicate compounds, water-soluble or colloidal water-soluble polymers.

According to some embodiments, the at least one rheology modifier is selected from magnesium aluminum silicates, magnesium aluminate metasilicate, cellulose ethers (e.g., hydroxyethyl cellulose, methyl cellulose, hydroxypropylmethyl cellulose), polyvinylalcohol, polyquaternium-10, guar gum, hydroxypropyl guar gum, xanthan gum, carrageenan, starch, gelatin, ghatty gum, gum Arabic, pectin, polyvinyl pyrrolidone, pyrrolidone containing copolymers, carboxyvinyl polymers and combinations thereof.

By some embodiments, the at least one rheology modifier is selected from magnesium aluminum silicates, xanthan gum, and combinations thereof.

According to some embodiments, the suspension comprises between about 0.05 wt % and 1.5 wt % of rheology modifier(s).

According to some embodiments, the suspension has a viscosity of at most 14,500 cP (centipoise). In some embodiments, the suspension has a viscosity ranging between about 1,100 and about 14,500 cP.

In order to increase the pesticide activity of the suspension or increase its effective range, one or more additional insecticide can be added. By some embodiments, the additional insecticide is selected from diafenthiuron, diflubenzuron, novaluron, lufenuron and any combinations thereof. By some other embodiments, the additional insecticide is diafenthiuron.

According to some embodiments the concentration of the at least one additional insecticide in the suspension is at least 5 wt %. By some embodiments, said additional insecticide is present in the suspension in a concentration ranging between about 5 wt % and about 50 wt %.

By some embodiments, the weight ratio (w/w) of the at least one ketoenol insecticide and said at least one additional insecticide in the suspension ranges between about 1:1 and 1:5. By other embodiments, the weight ratio (w/w) of at least one ketoenol insecticide and said at least one additional insecticide in the suspension is about 1:3.

The suspension can, by some embodiments, further comprises one or more additives, for example defoamers, buffers, solvents, antifreeze agents, colorants, odorants, antioxidants, UV-stabilizers, thickening agents, sticking agents, and dispersants.

By some embodiments, the suspension has a pH of between about 3 and 6.

As noted, the agrochemical suspensions of this disclosure are designed to be in stable concentrate form. Thus, by some embodiments, the suspension comprises at most 50 wt % water.

By another aspect of this disclosure, there is provided an agrochemical suspension in concentrate form, comprising:
a) spirotetramat,
b) from about 2 wt % to about 20 wt % of at least one adjuvant,
c) at least one steric and/or static stabilizer,
d) at least one rheomodifier, and
e) water.

By a further aspect of this disclosure, there is provided an agrochemical suspension in concentrate form, comprising:
a) spirotetramat,
b) from about 2 wt % to about 20 wt % of at least one adjuvant, selected from C8-C16 fatty alcohol alkoxylate,
c) at least one steric stabilizer selected from ethyleneoxide/propyleneoxide copolymers, acrylate/methacrylate copolymers, C10-C14 fatty alcohol ethoxylates and any combination thereof; and/or at least one static stabilizer selected from alcohol sulphates, alcohol sulfonates, alkyl sulphates, aryl sulphates, alkylaryl sulphates, alkyl-ether sulphates, aryl sulphonates, alkyl aryl sulfonates, lignosulfonates, fatty acid sulfonates (e.g. laurylsulfonate), mono-, di- or tristyryl phenol ethoxylate sulphates, taurate (N-methyl oleyl taurate), isethionate (cocoyl isethionate), and combinations thereof,
d) at least one rheomodifier, and
e) water.

By yet a further aspect of this disclosure, there is provided an agrochemical suspension in concentrate form, comprising:
a) spirotetramat and diafenthiuron,
b) from about 2 wt % to about 20 wt % of at least one adjuvant, selected from C8-C16 fatty alcohol alkoxylate,
c) at least one steric stabilizer selected from ethyleneoxide/propyleneoxide copolymers, acrylate/methacrylate copolymers, C10-C14 fatty alcohol ethoxylates and any combination thereof; and/or at least one static stabilizer selected from alcohol sulphates, alcohol sulfonates, alkyl sulphates, aryl sulphates, alkylaryl sulphates, alkyl-ether sulphates, aryl sulphonates, alkyl aryl sulfonates, lignosulfonates, fatty acid sulfonates (e.g. laurylsulfonate), mono-, di- or tristyryl phenol ethoxylate sulphates, taurate (N-methyl oleyl taurate), isethionate (cocoyl isethionate) and combinations thereof,
d) at least one rheomodifier, and
e) water.

By a further aspect, the present disclosure provides a pesticide composition comprising the suspension as described herein, and an agriculturally acceptable liquid carrier.

It is noted that in the context of the present disclosure, the term suspension refers to the concentrate, while the term composition refers to diluted form of the suspension, e.g. prepared shortly or immediately before application.

By some embodiments, the agriculturally acceptable liquid carrier is water.

By some other embodiments, the composition comprises about 100 g/L Spirotetramat.

By other embodiments, the composition further comprises about 300 g/L Diafenthiuron.

By another aspect, there is provided a method of controlling pest population in a plant, the method comprising applying the suspension or composition described herein onto the plant and/or the soil surrounding the plant.

By a further aspect, there is provided a method of protecting plants from insect infestation, the method comprising applying the suspension or composition described herein onto the plant and/or the soil surrounding the plant.

According to some embodiments, the suspension or composition described herein eliminates at least about 10%, 20%, 30%, 40%, 50%, 60%, 70% or even 80% of the insect population compared to the insect population before application of the suspension or composition.

By another aspect, there is provided a method for controlling and/or preventing animal pests comprising applying an effective amount of the suspension or composition to a location where the animal pest is to be controlled and/or prevented, so as to thereby control and/or prevent the animal pest.

The term control or controlling insect population is meant to encompass any of inhibiting or interfering with the normal lifecycle of the insect (at any stage thereof), growth regulation, or killing.

The suspension or composition can be used to eliminate or control infestations of animal pests such as Lepidoptera, Diptera, Hemiptera, Thysanoptera, Coleoptera, Hymenoptera and also other invertebrate pests (for example, acarine, nematode and mollusk pests).

In some embodiments, the location is a crop field.

In some embodiments, the suspension or composition is applied in an amount from about 0.6 L/ha (liter/Hectare) to about 2 L/ha.

In some embodiments, the suspension or composition is applied in an amount from about 60 g/ha (gram/Hectare) of spirotetramat to about 200 g/ha of spirotetramat.

In some embodiments, the suspension or composition is applied in an amount from about 180 g/ha of diafenthiuron to about 600 g/ha of diafenthiuron.

Insects, acarines, nematodes and mollusks are hereinafter collectively referred to as pests. The pests include pests associated with agriculture (i.e. growing of crops for food and fibre products), horticulture and animal husbandry, forestry and the storage of products of vegetable origin (such as fruit, grain and timber).

Non-limiting examples of pest species which may be controlled by the suspension or composition disclosed herein include Myzus persicae (aphid), Aphis gossypii (aphid), Aphis fabae (aphid), Lygus spp. (capsids), Dysdercus spp. (capsids), Nilaparvata lugens (planthopper), Nephotettix cincticeps (leafhopper), Nezara spp. (stinkbugs), Euschistus spp. (stinkbugs), Leptocorisa spp. (stinkbugs), Frankliniella occidentalis (thrip), Thrips spp. (thrips), Leptinotarsa decemlineata (Colorado potato beetle), Anthonomus grandis (boll weevil), Aonidiella spp. (scale insects), Pseudococcus spp. (mealybugs), Trialeurodes spp. (white flies), Bemisia tabaci (white fly), Ostrinia nubilalis (European corn borer), Spodoptera littoralis (cotton leafworm), Heliothis virescens (tobacco budworm), Helicoverpa armigera (cotton bollworm), Helicoverpa zea (cotton bollworm), Sylepta derogata (cotton leaf roller), Pieris brassicae (white butterfly), Plutella xylostella (diamond back moth), Agrotis spp. (cutworms), Chilo suppressalis (rice stem borer), Locusta migratoria (locust), Chortiocetes terminifera (locust), Diabrotica spp. (rootworms), Panonychus ulmi (European red mite), Panonychus citri (citrus red mite), Tetranychus urticae (two-spotted spider mite), Tetranychus cinnabarinus (carmine spider mite), Phyllocoptruta oleivora (citrus rust mite), Polyphagotarsonemus latus (broad mite), Brevipalpus spp. (flat mites), Liriomyza spp. (leafminer), Meloidogyne spp. (root knot nematodes), Globodera spp., Heterodera spp. (cyst nematodes), Pratylenchus spp. (lesion nematodes), Rhodopholus spp. (banana burrowing nematodes), Tylenchulus spp. (citrus nematodes), Haemonchus contortus (barber pole worm), Caenorhabditis elegans (vinegar eelworm), Trichostrongylus spp. (gastro intestinal nematodes), and Deroceras reticulatum (slug); from the order Acarina, for example, Acarus siro, Aceria sheldoni, Aculus schlechtendali, Amblyomma spp., Argas spp., Boophilus spp., Brevipalpus spp., Bryobia praetiosa, Calipitrimerus spp., Chorioptes spp., Dermanyssus gallinae, Eotetranychus carpini, Eriophyes spp., Hyalomma spp., Ixodes spp., Olygonychus pratensis, Ornithodoros spp., Panonychus spp., Phyllocoptruta oleivora, Polyphagotarsonemus latus, Psoroptes spp., Rhipicephalus spp., Rhizoglyphus spp., Sarcoptes spp., Tarsonemus spp. and Tetranychus spp.; from the order Coleoptera, for example, Agriotes spp., Anthonomus spp., Atomaria linearis, Chaetocnema tibialis, Cosmopolites spp., Curculio spp., Dermestes spp., Diabrotica spp., Epilachna spp., Eremnus spp., Leptinotarsa decemlineata, Lissorhoptrus spp., Melolontha spp., Orycaephilus spp., Otiorhynchus spp., Phlyctinus spp., Popillia spp., Psylliodes spp., Rhizopertha spp., Scarabeidae, Sitophilus spp., Sitotroga spp., Tenebrio spp., Tribolium spp. and Trogoderma spp.; from the order Diptera, for example, Aedes spp., Antherigona soccata, Bibio hortulanus, Calliphora erythrocephala, Ceratitis spp., Chrysomyia spp., Culex spp., Cuterebra spp., Dacus spp., Drosophila melanogaster, Fannia spp., Gastrophilus spp., Glossina spp., Hypoderma spp., Hyppobosca spp., Liriomyza spp., Lucilia spp., Melanagromyza spp., Musca spp., Oestrus spp., Orseolia spp., Oscinella frit, Pegomyia hyoscyami, Phorbia spp., Rhagoletis pomonella, Sciara spp., Stomoxys spp., Tabanus spp., Tannia spp. and Tipula spp.; from the order Heteroptera, for example Cimex spp., Distantiella theobroma, Dysdercus spp., Euchistus spp., Eurygaster spp., Leptocorisa spp., Nezara spp., Piesma spp., Rhodnius spp., Sahlbergella singularis, Scotino-phara spp. and Triatoma spp.; From the order Homoptera, for example Aleurothrixus floccosus, Aleyrodes brassicae, Aonidiella spp., Aphididae, Aphis spp., Aspidiotus spp., Bemisia tabaci, Ceroplaster spp., Chrysomphalus aonidium, Chrysomphalus dictyospermi, Coccus hesperidum, Empoasca spp., Eriosoma larigerum, Erythroneura spp., Gascardia spp., Laodelphax spp., Lecanium corni, Lepidosaphes spp., Macrosiphus spp., Myzus spp., Nephotettix spp., Nilaparvata spp., Parlatoria spp., Pemphigus spp., Planococcus spp., Pseudaulacaspis spp., Pseudococcus spp., Psylla spp., Pulvinaria aethiopica, Quadraspidiotus spp., Rhopalosiphum spp., Saissetia spp., Scaphoideus spp., Schizaphis spp., Sitobion spp., Trialeurodes vaporariorum, Trioza erytreae and Unaspis citri; from the order Hymenoptera, for example Acromyrmex, Atta spp., Cephus spp., Diprion spp., Diprionidae, Gilpinia polytoma, Hoplocampa spp., Lasius spp., Monomorium pharaonis, Neodiprion spp., Solenopsis spp. and Vespa spp.; from the order Lepidoptera, for example Acleris spp., Adoxophyes spp., Aegeria spp., Agrotis spp., Alabama argillaceae, Amylois spp., Anticarsia gemmatalis, Archips spp., Argyrotaenia spp., Autographa spp., Busseola fusca, Cadra cautella, Carposina nipponensis, ChNo spp., Choristoneura spp., Clysia ambiguella, Cnaphalocrocis spp., Cnephasia spp., Cochylis spp., Coleophora spp., Crocidolomia binotalis, Cryptophlebia leucotreta, Cydia spp., Diatraea spp., Diparopsis castanea, Earias spp., Ephestia spp., Eucosma spp., Eupoecilia ambiguella, Euproctis spp., Euxoa spp., Grapholita spp., Hedya nubiferana, Heliothis spp., Hellula undalis, Hyphantria cunea, Keiferia lycopersicella, Leucoptera scitella, Lithocollethis spp., Lobesia botrana, Lymantria spp., Lyonetia spp., Malacosoma spp., Mamestra brassicae, Manduca sexta, Operophtera spp., Ostrinia nubilalis, Pammene spp., Pandemis spp., Panolis flammea, Pectinophora gossypiela, Phthorimaea operculella, Pieris rapae, Pieris spp., Plutella xylostella, Prays spp., Scirpophaga spp., Sesamia spp., Sparganothis spp., Spodoptera spp., Synanthedon spp., Thaumetopoea spp., Tortrix spp., Trichoplusia ni and Yponomeuta spp.; from the order Thysanoptera, for example Frankliniella spp., Hercinothrips spp., Scirtothrips aurantii, Taeniothrips spp., Thrips palmi and Thrips tabaci; and from the order Thysanura, for example Lepisma saccharina.

The term plant means to denote any of the whole plant, plant parts (leaves, stems, twigs, roots, tubers, bulbs, trunks, shoots, saplings, flowers, inflorescences, buds, fruit, seeds, etc.), as well as propagation material.

The term crop means agricultural, cultivated, or horticultural crop, including seasonal, annual, semi-perennial and perennial crops.

Non-limiting examples of suitable crops include cereals (such as wheat, barley, rye, oats, rice, maize, sorghum), beet (such as sugar, fodder beet), fruit (for example pomaceous fruit, stone fruit or soft fruit, such as apples, pears, avocado, plums, peaches, almonds, cherries, berries, for example strawberries, raspberries, blackberries), cinnamonium, camphor, citrus fruit (such as oranges, lemons, grapefruit, tangerines), cucurbits (such as pumpkins, cucumbers, melons), vegetables (such as spinach, lettuce, asparagus, cabbages, carrots, onions, tomatoes, potatoes or peppers, chilli, okra, eggplants), leguminous crops (such as beans, lentils, peas, soy), oil crops (such as oilseed rape, mustard, poppies, olives, sunflowers, coconut, castor, cocoa, ground nuts), fibre plants (such as cotton, flax, hemp, jute), tobacco, nuts, coffee, sugarcane, tea, grapevines, hops, the plantain family, latex plants, ornamentals and lauraceae.

As used herein, the term about is meant to encompass deviation of 10% from the specifically mentioned value of a parameter, such as concentration, temperature, etc.

Unless otherwise specifically indicated, concentrations are provided in wt %, namely in weight percent out of the total weight of the formulation/composition.

Whenever a numerical range is indicated herein, it is meant to include any cited numeral (fractional or integral) within the indicated range. The phrases ranging ranges between a first indicate number and a second indicate number and “ranging/ranges from” a first indicate number “to” a second indicate number are used herein interchangeably and are meant to include the first and second indicated numbers and all the fractional and integral numerals therebetween.

Unless the context requires otherwise, the word comprise, and variations such as “comprises” and “comprising”, will be understood to imply the inclusion of a stated integer or step or group of integers or steps but not the exclusion of any integer or step or group of integers and steps.

Generally it is noted that the term . . . at least one . . . as applied to any component of a composition of the invention should be read to encompass one, two, three, four, five, or more different occurrences of said component in a formulation described herein.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

### DETAILED DESCRIPTION OF EMBODIMENTS

### Exemplary Formulations

Exemplary suspension formulations according to this disclosure are provided in Tables 1-1 and 1-2.

TABLE 1-1
Exemplary formulations for stable
suspensions with Tergitol TMN-6

| | | Form. A | Form. B |
|---|---|---|---|
| Ingredients | Function | (% wt) | (% wt) |
| Water (q.s) | Solvent | q.s | q.s |
| Magnesium aluminum | Rheology | 0.35 | 0.35 |
| silicate | modifier | | |
| (Vangel B) | | | |
| Propylene glycol | Antifreeze | 5.00 | 5.00 |
| | agent | | |
| Tergitol TMN-6 | Adjuvant | 6.80 | 6.80 |
| Silicon emulsion | Defoamer | 1.00 | 1.00 |
| (SAG 1572) | | | |
| Ethoxylated tristyrylphenol | Static | 6.00 | — |
| sulphate ammonium | stabilizer | | |
| (Tersperse 2218) | | | |
| Isotridecyl alcohol ethoxylate | Steric | — | 6.00 |
| (Alkont IT 60) | stabilizer | | |
| Acetic acid | Buffer | 0.83 | 0.83 |
| Sodium acetate | Buffer | 0.16 | 0.16 |
| Diafenthiuron | Insecticide | 29.77 | 29.77 |
| Spirotetramat | Insecticide | 9.81 | 9.81 |
| 1,2-benzisothiazolin-3-one | Biocide | 0.02 | 0.02 |
| (Proxel GXL) | | | |
| Xanthan gum | Rheology | 0.20 | 0.30 |
| (Rhodopol 23) | modifier | | |

| Total | 100 | 100 |
|---|---|---|
| Phase separation at 54° C., 2 weeks* | <2% phase | 3% phase |
| | separation | separation |
| Viscosity (cP) at ambient temp., 2 weeks | 1922 cP | 2282 cP |
| Viscosity (cP) at 54° C., 2 weeks | 1836 cP | 1792 cP |

*Accelerated aging protocol, correlating to 2-years in ambient conditions

TABLE 1-2
Exemplary formulations for stable suspensions with Atplus 245

| | | Form. C | Form. D | Form. E |
|---|---|---|---|---|
| Ingredients | Function | (% wt) | (% wt) | (% wt) |
| Water (q.s) | Solvent | q.s | q.s | q.s |
| Magnesium Aluminium | rheomodifier | 0.10 | 0.20 | 0.20 |
| silicate (Vangel B) | | | | |
| Propylene glycol | Antifreeze | 5.0 | 4.70 | 3.70 |
| | agent | | | |
| Alcohol alkoxylate | Adjuvant | 13.00 | 13.00 | 13.00 |
| (Atplus 245) | | | | |
| SAG 1572 | Defoamer | 1.0 | 0.69 | 0.63 |
| SAG 1538 | Defoamer | — | 0.25 | — |
| Acrylic graft co-polymer | Steric | — | 3.00 | 4.80 |
| (Tersperse 2500) | stabilizer | | | |
| Ethoxylated | Static | — | 1.00 | — |
| Tristyrylphenol phosphate | stabilizer | | | |
| (Soprophor 3D 33R) | | | | |
| Ethoxylated | Static | 6.00 | — | — |
| tristyrylphenol sulphate | stabilizer | | | |
| ammonium | | | | |
| (Tersperse 2218) | | | | |
| Tridecyl alcohol | Steric | — | — | 2.40 |
| ethoxylate (Alkont IT60) | stabilizer | | | |
| Polyalkylene oxide block | Steric | — | — | 1.54 |
| copolymer (Atlas G5002 | stabilizer | | | |
| L) | | | | |
| Acetic acid | Buffer | 0.83 | 0.83 | 0.83 |
| Sodium acetate | Buffer | 0.16 | 0.16 | 0.16 |
| Diafenthiuron | Insecticide | 29.5 | 29.09 | 29.09 |
| Spirotetramat | Insecticide | 10.00 | 9.61 | 9.61 |
| Proxel GXL | Biocide | 0.20 | 0.20 | 0.20 |
| Rhodopol 23 | rheomodifier | 0.04 | 0.10 | 0.10 |

| | | | |
|---|---|---|---|
| Total | 100.00 | 100.00 | 100.00 |

The exemplary formulations were prepared according to the following general preparation process:

Vangel B was slowly added to water (90% of the entire water content of the formulation) and mixed until complete dissolution. Then, propylene glycol (80% of the total required quantity), Tergitol TMN 6, SAG 1572 (50% of the total required quantity), and Tersperse 2218 were added in sequence and stirred at 700-800 RPM using propeller stirrer for 10 min followed by addition of glacial acetic acid and sodium acetate with continuous stirring. Spirotetramat and Diafenthiuron were added and homogenized for 5 min at 4000-6000 rpm followed by milling in EMI bead mill at 2500 RPM for 30-45 min, until the particle size was less than 8 microns. The milled suspension slurry was stirred with the remaining quantity of defoamer and continued stirring at 1000-1200 RPM. Later, appropriate quantity of rheology modifier (Xanthan gum) gel solution was added to this milled suspension to obtain viscosity around 1200-2000 cP.

Rheology modifier (Xanthan gum) gel solution was prepared the previous day by mixing water (remaining 10% quantity), Xanthan gum, Proxel GXL, and propylene glycol (remaining 20% quantity) with continuous stirring for 3-4 hours and kept ready.

The impact of various steric stabilizers on stability of the formulations was assessed, as detailed in Tables 2-1 and 2-2. Acceptable stability results were considered to be below 5% phase separation.

TABLE 2-1
Unstable formulations of Tergitol TMN6
with different steric stabilizers

| Ingredients | wt % |
|---|---|
| Water (g.s) | q.s. |
| Vangel B | 0.35 |
| Propylene glycol | 5.00 |
| Acetic Acid | 0.83 |
| Sodium Acetate | 0.16 |
| Trimethyl nonyl ethoxylate (Tergitol TMN 6) | 6.80 |
| SAG 1572 | 1.00 |
| Steric stabilizer | See Table 2-2 |
| Diafenthiuron | 29.77 |
| Spirotetramat | 9.79 |
| Proxel GXL | 0.02 |
| Xanthan Gum (Rhodopol 23) | 0.20 |
| Total | 100 |

TABLE 2-2
phase separation and viscosity data

| | | Phase | | | | |
|---|---|---|---|---|---|---|
| | | separation | Viscosity (cP) | | Viscosity (cP) | |
| | | 54° C., | at Ambient, | | at 54° C., | |
| Steric stabilizer | % w/w | 2 weeks | 2 weeks | | 2 weeks | |
| Ethoxylated Tristyrylphenol | 6.00 | 8% phase | 12980 | cP | 11550 | cP |
| (Soprophor BSU) | | separation | | | | |
| Ethoxylated Propoxylated | 6.00 | 13% phase | 13140 | cP | 11330 | cP |
| Tristyrylphenol | | separation | | | | |
| (Soprophor 796/P) | | | | | | |
| Ethoxylated Tristyrylphenol | 3.00 | 8% phase | 3454 | cP | 3353 | cP |
| phosphate | | separation | | | | |
| (Soprophor 3D 33R) | | | | | | |
| Ethoxylated Tristyrylphenol | 6.00 | 8% phase | 12830 | cP | 7753 | cP |
| phosphate (Soprophor 3D | | separation | | | | |
| 33R) | | | | | | |
| Tridecyl alcohol ethoxylate | 6.00 | 6% phase | 5232 | cP | 5845 | cP |
| phosphate (Hostaphat 1306) | | separation | | | | |
| Polyethoxy sorbitan | 6.00 | 6% phase | 14250 | cP | 13880 | cP |
| monooleate (Sorbox 80) | | separation | | | | |
| Polyethoxy sorbitan | 6.00 | No phase | 13170 | cP | 12450 | cP |
| monolaurate (Sorbox 20) | | separation | | | | |
| Cetyl alcohol ethoxylate | 6.00 | <1% phase | 13180 | cP | 13460 | cP |
| (Brij C-10) | | separation | | | | |
| Oleyl alcohol ethoxylate | 6.00 | <1% phase | 12580 | cP | 12740 | cP |
| (Brij O-10) | | separation | | | | |

It is clearly shown in Tables 1-1 to 1-2, that adjuvants, more specifically those selected from the group of C8-C16 fatty alcohol alkoxylate, can be formulated to provide a built-in stable product using different types of stabilizers. Formulations A-E showed no or minimal phase separation and desired viscosity properties.

Formulations in Tables 2-1 and 2-2 differ only in the type of steric stabilizer added, and are meant to serve as comparative data. Various types of steric stabilizers were tested, and the desired effect was not achieved due to high level of phase separation and/or high viscosity.

The effect of various rheology modifiers on the formulations is provided in Tables 3-1 and 3-2.

TABLE 3-1
Unstable formulations of Atplus 245 without Vangel B

| | Form. 11 | Form. 12 | Form. 13 |
|---|---|---|---|
| Ingredients | (% wt) | (% wt) | (% wt) |
| Water (q.s) | q.s | q.s | q.s |
| Magnesium Aluminium | — | — | — |
| silicate (Vangel B) | | | |
| Propylene glycol | 4.0 | 4.0 | 4.0 |
| Alcohol alkoxylate | 13.00 | 13.00 | 13.00 |
| (Atplus 245) | | | |
| Silcolapse 432 | — | 1.00 | 1.00 |
| SAG 1572 | 0.69 | — | — |
| SAG 1538 | 0.25 | — | — |
| Tersperse 2500 | 3.00 | 3.00 | — |
| Soprophor 3D33R | 1.00 | 1.00 | 3.00 |
| Acetic acid | 0.83 | 0.83 | 0.83 |
| Sodium acetate | 0.16 | 0.16 | 0.16 |
| Diafenthiuron | 29.53 | 29.53 | 29.53 |
| Spirotetramat | 9.84 | 9.84 | 9.84 |
| Proxel GXL | 0.20 | 0.20 | 0.20 |
| Rhodopol 23 | 0.04 | 0.10 | 0.10 |
| Total | 100.00 | 100.00 | 100.00 |
| % Phase separation at | 12% | 14% | 17% |
| 54° C., 2 weeks | | | |

TABLE 3-2
Unstable formulations of Tergitol TMN-6 without Vangel B

| | Form. 14 | Form. 15 | Form. 16 | Form. 17 | Form. 18 | Form. 19 |
|---|---|---|---|---|---|---|
| Ingredients | (% wt) | (% wt) | (% wt) | (% wt) | (% wt) | (% w/w) |
| Water (q.s) | q.s | q.s | q.s | q.s | q.s | q.s |
| Vangel B | 0.0 | 0.0 | 0.0 | 0.20 | 0.20 | 0.20 |
| Propylene glycol | 5.00 | 5.00 | 5.00 | 5.00 | 5.00 | 5.00 |
| Acetic Acid | 0.83 | 0.83 | 0.83 | 0.83 | 0.83 | 0.83 |
| Sodium Acetate | 0.16 | 0.16 | 0.16 | 0.16 | 0.16 | 0.16 |
| Tergitol TMN 6 | 6.80 | 6.80 | 6.80 | 6.80 | 6.80 | 6.80 |
| SAG 1572 | 1.00 | 1.00 | 1.00 | 1.00 | 1.00 | 1.00 |
| Tersperse 2218 | 6.00 | 6.00 | 6.00 | 6.00 | 6.00 | 6.00 |
| Diafenthiuron | 29.77 | 29.77 | 29.77 | 29.77 | 29.77 | 29.77 |
| Spirotetramat | 9.79 | 9.79 | 9.79 | 9.79 | 9.79 | 9.79 |
| Proxel GXL | 0.02 | 0.02 | 0.02 | 0.02 | 0.02 | 0.02 |
| Rhodopol 23 | 0.20 | 0.40 | 0.60 | 0.20 | 0.40 | 0.60 |
| Total | 100.00 | 100.00 | 100.00 | 100.00 | 100.00 | 100.00 |
| Viscosity cP | 950/ | 1288/ | 1615/ | 1360/ | 1645/ | 2412/ |
| (AMB, 0 day | 945/ | 1150/ | 1430/ | 1263/ | 1520/ | 2105/ |
| AMB, 2 weeks | 835 | 1018 | 1213 | 1150 | 1378 | 1880 |
| 54 C., 2 weeks) | | | | | | |
| % Phase | 17% | 15% | 16% | 9% | 17% | 15% |
| separation at | | | | | | |
| 54° C., 2 weeks | | | | | | |

### Efficacy and Phytotoxicity Test Protocols & Methodology

Formulations of this disclosure were field tested for various crops, assessing their efficacy against several insect infestations and for phytotoxicity symptoms. The tests were carried out according to two testing protocols, as detailed in Tables 4-1 and 4-2.

The exact recipe of Spirotetramat 100+Diafenthiuron 300 SC with Tergitol TMN-6 is as described in table 1-1 form A.

The exact recipe of Spirotetramat 100+Diafenthiuron 300 SC with Atplus 245 is as described in table 1-2 form C.

TABLE 4-1
Test protocol 1

| | | Dose | Dosing rate |
|---|---|---|---|
| | Treatment | (g/ha) | (ml/ha) |
| 1 | Untreated control | 0 | 0 |
| 2 | Spirotetramat 100 + Diafenthiuron 300 SC with Atplus 245 | 63 + 189 | 630 |
| 3 | Spirotetramat 100 + Diafenthiuron 300 SC with Atplus 245 | 72 + 216 | 720 |
| 4 | Spirotetramat 100 + Diafenthiuron 300 SC with Atplus 245 | 90 + 270 | 900 |
| 5 | Spirotetramat 100 + Diafenthiuron 300 SC with Atplus 245 | 180 + 540 | 1800 |
| 6 | Spirotetramat 100 + Diafenthiuron 300 SC with Tergitol TMN-6 | 63 + 189 | 630 |
| 7 | Spirotetramat 100 + Diafenthiuron 300 SC with Tergitol TMN-6 | 72 + 216 | 720 |
| 8 | Spirotetramat 100 + Diafenthiuron 300 SC with Tergitol TMN-6 | 90 + 270 | 900 |
| 9 | Spirotetramat 100 + Diafenthiuron 300 SC with Tergitol TMN-6 | 180 + 540 | 1800 |
| 10 | Spirotetramat 150 + Diafenthiuron 450 SC | 90 + 270 | 600 |
| 11 | Spirotetramat 150 + Diafenthiuron 450 SC | 180 + 540 | 1200 |
| 12 | Spirotetramat 15% OD | 90 | 600 |
| 13 | Diafenthiuron 50% WP | 300 | 600 |
| 14* | TRASSID (Spinetoram 50 + Diafenthiuron 400) SC | 37.5 + 300 | 750 |

*commercial products references

TABLE 4-2
Test protocol 2

| | | Dose | Dosing rate |
|---|---|---|---|
| | Treatment | (g/ha) | (ml/ha) |
| 1 | Untreated control | 0 | 0 |
| 2 | Spirotetramat 15% OD | 90 | 600 |
| 3 | Spirotetramat 15% OD | 180 | 1200 |
| 4 | Diafenthiuron 50% WP | 300 | 600 |
| 5 | Diafenthiuron 50% WP | 600 | 1200 |
| 6 | Spirotetramat 100 + Diafenthiuron 300 SC | 75 + 225 | 720 |
| | with Tergitol TMN-6 | | |
| 7 | Spirotetramat 100 + Diafenthiuron 300 SC | 150 + 450 | 1500 |
| | with Tergitol TMN-6 | | |
| 8 | Spirotetramat 150 + Diafenthiuron 450 SC | 90 + 270 | 600 |
| 9 | Spirotetramat 150 + Diafenthiuron 450 SC | 180 + 540 | 1200 |
| 10* | TRASSID (Spinetoram 50 + Diafenthiuron 400) SC | 37.5 + 300 | 750 |

*commercial products references

### Methodology

Mites and aphids—Five (5) plants were randomly selected for observation in each tested plot. Number of mites and aphids was counted on day 0 (before application), 3, 5, 7 and 10 days after first application. Three (3) leaves were observed on each of the 5 plants (total number of leaved observed per plot was 45).

Whitefly adults—Five (5) plants were randomly selected for observation in each tested plot. Number of adult whiteflies on the lower side of two top leaves and one middle leaf in each of the 5 plants was recorded. Knockdown effect of the formulation within 4 hours from application, as well as 1 day after first application (DAA), was assessed. Total number of leaved observed per plot was 45.

Whitefly nymphs—Five (5) plants were randomly selected for observation in each tested plot. The nymphs on top, middle and bottom leaves were circled and counted. The number of live nymphs was recorded before application and on days 3, 7 and 10 after first application. Total number of leaved observed per plot was 45.

Mealybugs—Ten (10) plants were randomly selected for observation in each tested plot. For each plant, 3 twigs were observed (total of 30 twigs per plot). The number of nymphs (crawlers) and adults of mealybug per 5 cm apical shoot of twig, before and after application.

Diamondback moth (DBM)—Five (5) plants were randomly selected for observation in each tested plot. Number of L1-2 Larva on a plant were counted. The number of live l 1-2 larva were recorded before application and on days 3, 7 and 10 after first application.

In Tables below the alphabetic index 1-I indicates the DMRT rank.

### Example 1: Tomato

Efficacy against mites was assessed for tomato plots, as detailed in Table 5-1 (DAA=days after first application; ROC=reduction over control).

Both formulations with Tergitol TMN-6 and Atplus 245 have shown better efficacy compared to the formulations without adjuvants.

TABLE 5-1
Test details, tomatoes

| Trial details | Trial 1 | Trial 2 |
|---|---|---|
| Protocol | Protocol 1 | Protocol 1 |
| Variety | Sahoo | TM744 |
| Soil type | Red soil | Black soil |
| Design & plot size | RBD, 25 sqm | RBD with three |
| | | replications, |
| | | 25 sqm |
| Crop stage at trial initiation | 90 days | 64 days |
| Pest infestation at trial | 4-5 mites/leaf | Phytotoxicity |
| initiation | | study |
| Application method & | Foliar spray | Foliar spray |
| Water volume | 500 L/Ha | 500 L/Ha |
| Application equipment | Knapsack sprayer | Knapsack sprayer |
| | | fitted with hollow |
| | | cone nozzle |

TABLE 5-2
Efficacy results, tomato mites (Tetranychus urticae)

| | | | Dose | | | | | | | | | | |
|---|---|---|---|---|---|---|---|---|---|---|---|---|---|
| | | Dose | rate | Pre | Mites count per plant (3 leaves/plant) | | | | | | | | |
| | Treatment | g/Ha | ml/Ha | count | 1 DAA | | % ROC | 3DAA | | % ROC | 7 DAA | | % ROC |
| 1 | Untreated control | 0 | 0 | 15.4 | 16.0 | a | 0 | 18.6 | a | 0 | 22.8 | a | 0 |
| 2 | SPT100 + DFN300SC, Atplus 245 | 90 + 270 | 900 | 15.2 | 7.0 | bcd | 56 | 2.0 | fg | 89 | 1.2 | def | 95 |
| 3 | SPT100 + DFN300SC, Atplus 245 | 180 + 540 | 1800 | 15.2 | 6.0 | bcd | 63 | 1.6 | fgh | 91 | 0.4 | ef | 98 |
| 4 | SPT100 + DFN300SC, Tergitol | 63 + 189 | 630 | 15.6 | 7.0 | Bcd | 56 | 2.0 | fg | 89 | 1.2 | def | 95 |
| 5 | SPT100 + DFN300SC, Tergitol | 72 + 216 | 720 | 13.6 | 5.0 | cd | 69 | 0.8 | gh | 96 | 0.0 | f | 100 |
| 6 | SPT100 + DFN300SC, Tergitol | 90 + 270 | 900 | 18.6 | 4.6 | cd | 71 | 1.2 | fgh | 94 | 0.0 | f | 100 |
| 7 | SPT100 + DFN300SC, Tergitol | 180 + 540 | 1800 | 15.6 | 3.4 | d | 79 | 0.4 | h | 98 | 0.0 | f | 100 |
| 8 | SPT150 + DFN450SC | 90 + 270 | 600 | 18.4 | 7.8 | bcd | 51 | 5.4 | de | 71 | 3.8 | de | 83 |
| 9 | SPT150 + DFN450SC | 180 + 540 | 1200 | 15.4 | 7.4 | bcd | 54 | 2.4 | f | 87 | 2.0 | def | 91 |
| 10 | SPT 15% OD | 90 | 600 | 19.2 | 8.4 | bc | 48 | 7.2 | c | 61 | 7.4 | bc | 68 |
| 11 | DFN 50% WP | 300 | 600 | 19.4 | 9.8 | b | 39 | 9.4 | b | 49 | 10.8 | b | 53 |
| 12 | TRASSID | 37.5 + 300 | 750 | 19.0 | 7.8 | bcd | 51 | 6.6 | cd | 65 | 4.6 | cd | 80 |

| | | | |
|---|---|---|---|
| CD@5% | 4.63 | 1.44 | 3.05 |

### Example 2: Cotton

Efficacy against mites were assessed for cotton plots, as detailed in Table 6-1. Efficacy results are detailed in Tables 6-2-1 to 6-2-4 (DAA=days after first application; ROC=reduction over control).

Formulations with Tergitol TMN-6 have shown better efficacy compared to the formulations without adjuvants and compared to the commercial products. Residuality was 7-10 days.

The exact recipe of Spirotetramat 100+Diafenthiuron 300 SC with Tergitol TMN-6 is as described in table 1-1 form A.

The exact recipe of Spirotetramat 100+Diafenthiuron 300 SC with Atplus 245 is as described in table 1-2 form C.

TABLE 6-1
Test details, cotton

| Trial details | Trial 1 | Trial 2 |
|---|---|---|
| Variety | Rasi 659 | Rasi 776 |
| Soil type | Clay soil | Black soil |
| Design & plot size | RBD, 30 sqm | RBD, 30 sqm |
| Crop stage at trial | 120 days | 120 days |
| initiation | | |
| Pest infestation at trial | 13-14 mealybug | 8-10 WF |
| initiation | crawlers/leaf; | adults/leaf |
| | 4-6 WF nymphs/leaf | 6-8 WF nymphs/leaf |
| Application method & | Foliar spray | Foliar spray |
| Water volume | 500 L/Ha | 500 L/Ha |
| Application equipment | Knapsack sprayer fitted | Knapsack sprayer |
| | with hollow cone nozzle | fitted with hollow |
| | | cone nozzle |

TABLE 6-2-1
Efficacy results, cotton whiteflies (Bemisia tabaci), location 1

| | | Dose | Pre | Whiteflies count per plant (3 leaves/plant) | | | | | | | | | | |
|---|---|---|---|---|---|---|---|---|---|---|---|---|---|---|
| | Treatment | g/Ha | count | 1DAA | % ROC | 3DAA | | % ROC | 7DAA | | % ROC | 10DAA | | % ROC |
| 1 | Untreated control | 0 | 6.4 | 7.4 | 0 | 8.1 | a | 0 | 9.3 | a | 0 | 10.6 | a | 0 |
| 2 | SPT 15% OD | 90 | 6.7 | 6.5 | 11 | 5.8 | b | 28 | 5.1 | b | 45 | 6.3 | bc | 40 |
| 3 | SPT 15% OD | 180 | 6.5 | 6.1 | 17 | 5.5 | b | 31 | 4.5 | bcd | 50 | 5.8 | cd | 45 |
| 4 | DFN 50% WP | 300 | 6.3 | 6.2 | 15 | 5.6 | b | 30 | 4.4 | cde | 52 | 5.6 | b | 46 |
| 5 | DFN 50% WP | 600 | 5.8 | 5.8 | 21 | 5.4 | c | 33 | 4.2 | def | 55 | 5.4 | bc | 49 |
| 6 | SPT100 + DFN300SC, | 75 + 225 | 6.1 | 6.2 | 16 | 4.5 | d | 44 | 2.2 | fg | 77 | 2.9 | de | 72 |
| | Tergitol | | | | | | | | | | | | | |
| 7 | SPT100 + DFN300SC, | 150 + 450 | 6.3 | 6.1 | 17 | 4.0 | e | 48 | 1.8 | g | 80 | 2.6 | e | 75 |
| | Tergitol | | | | | | | | | | | | | |
| 8 | SPT150 + DFN450SC | 90 + 270 | 5.9 | 5.9 | 20 | 5.0 | cd | 38 | 4.0 | bc | 57 | 3.8 | bc | 63 |
| 9 | SPT150 + DFN450SC | 180 + 540 | 6.1 | 5.4 | 26 | 4.6 | d | 43 | 3.5 | bcd | 62 | 3.5 | cd | 66 |
| 10 | TRASSID | 37.5 + 300 | 5.8 | 5.7 | 23 | 5.1 | c | 36 | 3.4 | bc | 64 | 4.0 | bc | 62 |

| | | | |
|---|---|---|---|
| CD@5% | 0.40 | 0.95 | 0.77 |

TABLE 6-2-2
Efficacy results, cotton mealybugs (Phenacoccus solenopsis), location 1

| | | Dose | Pre | mealybugs count per plant (3 leaves/plant) | | | | | | | | | | | |
|---|---|---|---|---|---|---|---|---|---|---|---|---|---|---|---|
| | Treatment | g/Ha | count | 3DAA | | % ROC | 7DAA | | % ROC | 10DAA | | % ROC | 15DAA | | % ROC |
| 1 | Untreated control | 0 | 15.0 | 9.3 | a | 0 | 18.1 | a | 0 | 19.2 | a | 0 | 21.0 | a | 0 |
| 2 | SPT 15% OD | 90 | 14.7 | 5.1 | b | 17 | 9.4 | cd | 48 | 9.8 | d | 49 | 12.6 | de | 40 |
| 3 | SPT 15% OD | 180 | 13.9 | 4.5 | bc | 23 | 8.5 | d | 53 | 8.7 | e | 55 | 12.0 | e | 43 |
| 4 | DFN 50% WP | 300 | 14.2 | 4.4 | cd | 35 | 9.1 | cd | 50 | 11.8 | bc | 38 | 14.3 | b | 32 |
| 5 | DFN 50% WP | 600 | 15.1 | 4.2 | de | 41 | 9.4 | cd | 48 | 10.9 | c | 43 | 13.0 | cd | 38 |
| 6 | SPT100 + DFN300SC, | 75 + 225 | 14.9 | 2.2 | de | 41 | 3.8 | f | 79 | 5.6 | f | 71 | 8.0 | g | 62 |
| | Tergitol | | | | | | | | | | | | | | |
| 7 | SPT100 + DFN300SC, | 150 + 450 | 14.3 | 1.8 | e | 48 | 3.4 | f | 81 | 4.1 | g | 79 | 6.9 | h | 67 |
| | Tergitol | | | | | | | | | | | | | | |
| 8 | SPT150 + DFN450SC | 90 + 270 | 14.6 | 4.0 | de | 41 | 6.5 | e | 64 | 8.5 | e | 56 | 12.0 | e | 43 |
| 9 | SPT150 + DFN450SC | 180 + 540 | 14.8 | 3.5 | de | 43 | 4.4 | f | 75 | 8.1 | e | 58 | 10.8 | f | 48 |
| 10 | TRASSID | 37.5 + 300 | 14.1 | 3.4 | cd | 31 | 9.8 | bc | 46 | 12.3 | b | 36 | 13.1 | cd | 37 |

| | | | | |
|---|---|---|---|---|
| CD@5% | 2.05 | 1.06 | 1.00 | 0.75 |

TABLE 6-2-3
Efficacy results, cotton aphids (Aphis gossypii), location 1

| | | Dose | Pre | aphids count per plant (3 leaves/plant) | | | | | | | | |
|---|---|---|---|---|---|---|---|---|---|---|---|---|
| | Treatment | g/Ha | count | 3DAA | | % ROC | 7DAA | | % ROC | 10DAA | | % ROC |
| 1 | Untreated control | 0 | 24.6 | 27.1 | a | 0 | 28.3 | a | 0 | 29.2 | a | 0 |
| 2 | SPT 15% OD | 90 | 24.3 | 21.5 | b | 21 | 13.9 | b | 51 | 10.2 | b | 65 |
| 3 | SPT 15% OD | 180 | 24.1 | 21.2 | b | 22 | 12.8 | b | 55 | 9.1 | c | 69 |
| 4 | DFN 50% WP | 300 | 25.0 | 7.6 | c | 72 | 4.2 | c | 85 | 7.5 | d | 74 |
| 5 | DFN 50% WP | 600 | 25.3 | 8.0 | c | 70 | 3.1 | cd | 89 | 6.9 | de | 76 |
| 6 | SPT100 + DFN300SC, | 75 + 225 | 24.5 | 4.9 | ef | 82 | 1.6 | ef | 94 | 1.2 | h | 96 |
| | Tergitol | | | | | | | | | | | |
| 7 | SPT100 + DFN300SC, | 150 + 450 | 24.6 | 4.3 | f | 84 | 0.7 | f | 97 | 1.2 | h | 96 |
| | Tergitol | | | | | | | | | | | |
| 8 | SPT150 + DFN450SC | 90 + 270 | 25.4 | 5.8 | de | 79 | 3.6 | cd | 87 | 3.5 | g | 88 |
| 9 | SPT150 + DFN450SC | 180 + 540 | 25.4 | 5.2 | def | 81 | 3.2 | cd | 89 | 3.1 | g | 89 |
| 10 | TRASSID | 37.5 + 300 | 25.4 | 6.2 | d | 77 | 2.4 | de | 91 | 6.3 | ef | 78 |

| | | | |
|---|---|---|---|
| CD@5% | 1.24 | 1.35 | 1.03 |

TABLE 6-2-4
Efficacy results, cotton whiteflies nymphs (Bemisia tabaci), location 2

| | | | Dose | | | | | | | | | | |
|---|---|---|---|---|---|---|---|---|---|---|---|---|---|
| | | Dose | rate | Pre | Whiteflies nymphs count per plant (3 leaves/plant) | | | | | | | | |
| | Treatment | g/Ha | ml/Ha | count | 3DAA | | % ROC | 7DAA | | % ROC | 10DAA | | % ROC |
| 1 | Untreated control | 0 | 0 | 6.11 | 6.38 | a | 0 | 8.22 | a | 0 | 7.91 | a | 0 |
| 2 | SPT 15% OD | 90 | 600 | 5.75 | 2.93 | b | 54 | 4.00 | c | 51 | 5.67 | b | 28 |
| 3 | SPT 15% OD | 180 | 1200 | 6.42 | 2.53 | b | 60 | 3.56 | c | 57 | 5.07 | b | 36 |
| 4 | DFN 50% WP | 300 | 600 | 6.04 | 1.91 | cd | 70 | 2.11 | de | 74 | 4.13 | c | 48 |
| 5 | DFN 50% WP | 600 | 1200 | 6.07 | 1.62 | de | 75 | 2.71 | ef | 79 | 2.75 | d | 65 |
| 6 | SPT100 + DFN300SC, | 75 + 225 | 750 | 6.16 | 0.42 | f | 93 | 0.87 | gh | 89 | 1.05 | gh | 87 |
| | Tergitol | | | | | | | | | | | | |
| 7 | SPT100 + DFN300SC, | 150 + 450 | 1500 | 6.38 | 0.07 | f | 99 | 0.58 | h | 93 | 0.53 | h | 93 |
| | Tergitol | | | | | | | | | | | | |
| 8 | SPT150 + DFN450SC | 90 + 270 | 600 | 6.40 | 0.65 | f | 91 | 1.33 | fg | 84 | 1.80 | ef | 77 |
| 9 | SPT150 + DFN450SC | 180 + 540 | 1200 | 6.60 | 0.29 | f | 95 | 0.94 | gh | 89 | 1.13 | fgh | 86 |
| 10 | TRASSID | 37.5 + 300 | 750 | 6.33 | 1.49 | de | 77 | 2.31 | d | 72 | 2.07 | e | 74 |

| | | | |
|---|---|---|---|
| CD@5% | 0.59 | 0.35 | 0.67 |

### Example 3: Okra

Efficacy against mites were assessed for okra plots, as detailed in Table 7-1. Efficacy results are detailed in Tables 7-2-1 and 7-2-2 (DAA=days after first application; ROC=reduction over control).

The exact recipe of Spirotetramat 100+Diafenthiuron 300 SC with Tergitol TMN-6 is as described in table 1-1 form A.

The exact recipe of Spirotetramat 100+Diafenthiuron 300 SC with Atplus 245 is as described in table 1-2 form C.

TABLE 7-1
Test details, okra

| Trial details | Trial 1 | Trial 2 |
|---|---|---|
| Variety | Abha | NS7774 |
| Soil type | Black soil | Red soil |
| Design & plot size | LPT, 50 sqm | RBD, 25 sqm |
| Crop stage at trial | 73 days | 58 days |
| initiation | | |
| Pest infestation | 3-4 WF nymphs/leaf | 10-15 mites/leaf |
| at trial initiation | | |
| Application method & | Foliar spray | Foliar spray |
| Water volume | 375 L/Ha | 500 L/Ha |
| Application equipment | Knapsack sprayer fitted | Knapsack sprayer |
| | with hollow cone nozzle | fitted with hollow |
| | | cone nozzle |

TABLE 7-2-1
Efficacy results, okra whiteflies nymphs (Bemisia tabaci)

| | | | Dose | | | | | | | | | | |
|---|---|---|---|---|---|---|---|---|---|---|---|---|---|
| | | Dose | rate | Pre | Whiteflies nymphs count per plant (3 leaves/plant) | | | | | | | | |
| | Treatment | g/Ha | ml/Ha | count | 3DAA | | % ROC | 7DAA | | % ROC | 710DAA | | % ROC |
| 1 | Untreated control | 0 | 0 | 7.00 | 16.1 | a | 0 | 17.1 | a | 0 | 18.4 | a | 0 |
| 2 | SPT100 + DFN300SC, | 90 + 270 | 900 | 7.00 | 4.67 | i | 71 | 1.33 | i | 92 | 2.44 | i | 87 |
| | Tergitol | | | | | | | | | | | | |
| 3 | SPT100 + DFN300SC, | 180 + 540 | 1800 | 6.78 | 3.00 | j | 81 | 0.00 | j | 100 | 0.78 | j | 96 |
| | Tergitol | | | | | | | | | | | | |
| 4 | SPT150 + DFN450SC | 90 + 270 | 600 | 6.89 | 11.6 | b | 28 | 9.11 | b | 47 | 11.1 | b | 40 |
| 5 | SPT150 + DFN450SC | 180 + 540 | 1200 | 7.11 | 10.2 | bcd | 36 | 7.56 | cde | 56 | 9.89 | bcd | 46 |
| 6 | SPT 15% OD | 90 | 600 | 7.00 | 8.67 | efg | 46 | 6.89 | ef | 60 | 8.44 | e | 54 |
| 7 | DFN 50% WP | 300 | 600 | 6.89 | 10.8 | bc | 33 | 8.33 | bc | 51 | 9.89 | bcd | 46 |
| 8 | TRASSID | 37.5 + 300 | 750 | 6.67 | 10.0 | cde | 38 | 7.89 | cd | 54 | 9.56 | cde | 48 |

| | | | |
|---|---|---|---|
| CD@5% | 1.52 | 0.92 | 1.32 |

TABLE 7-2-2
Efficacy results, okra mites (Tetranychus urticae)

| | | | Dose | | | | | | | | | | | | | |
|---|---|---|---|---|---|---|---|---|---|---|---|---|---|---|---|---|
| | | Dose | rate | Pre | mites count per plant (3 leaves/plant) | | | | | | | | | | | |
| | Treatment | g/Ha | ml/Ha | count | 1DAA | | % ROC | 3DAA | | % ROC | 7DAA | | % ROC | 10DAA | | % ROC |
| 1 | Untreated control | 0 | 0 | 25.4 | 28.6 | a | 0 | 34.8 | a | 0 | 42.4 | a | 0 | | a | 0 |
| 2 | SPT 15% OD | 90 | 600 | 24.8 | 16.2 | bcd | 43 | 14.8 | bc | 57 | 15.2 | cd | 65 | 17.4 | cd | 63 |
| 3 | SPT 15% OD | 180 | 1200 | 25.6 | 15.0 | bcd | 47 | 12.8 | bc | 63 | 11.8 | def | 72 | 14.6 | d | 69 |
| 4 | DFN 50% WP | 300 | 600 | 29.4 | 19.6 | b | 31 | 19.0 | b | 45 | 20.0 | bc | 53 | 25.6 | b | 46 |
| 5 | DFN 50% WP | 600 | 1200 | 25.6 | 16.2 | bcd | 43 | 13.4 | bc | 62 | 13.8 | de | 67 | 19.4 | c | 59 |
| 6 | SPT100 + DFN300SC, | 75 + 225 | 750 | 25.2 | 11.0 | d | 61 | 5.4 | de | 84 | 2.0 | hi | 95 | 1.4 | fg | 97 |
| | Tergitol | | | | | | | | | | | | | | | |
| 7 | SPT100 + DFN300SC, | 150 + 450 | 1500 | 2.8 | 10.2 | d | 64 | 0.6 | e | 98 | 1.6 | i | 96 | 0.0 | g | 100 |
| | Tergitol | | | | | | | | | | | | | | | |
| 8 | SPT150 + DFN450SC | 90 + 270 | 600 | 26.6 | 13.6 | bcd | 52 | 10.0 | cd | 71 | 7.2 | fgh | 83 | 4.2 | f | 91 |
| 9 | SPT150 + DFN450SC | 180 + 540 | 1200 | 23.6 | 13.0 | cd | 54 | 9.0 | cd | 74 | 5.8 | ghi | 86 | 3.2 | fg | 93 |
| 10 | TRASSID | 37.5 + 300 | 750 | 27.2 | 16.2 | bcd | 43 | 13.2 | bc | 62 | 9.6 | efg | 77 | 9.0 | e | 81 |

| | | | | |
|---|---|---|---|---|
| CD@5% | 6.47 | 6.28 | 5.28 | 4.13 |

Formulations with Tergitol TMN-6 have shown improved control of okra whiteflies population, and higher control over okra mites' population. Formulations with Tergitol have shown superior results also over the commercial products.

### Example 4: Cauliflower

Efficacy against aphides and DBM were assessed for cauliflower plots, as detailed in Table 8-1. Efficacy results are detailed in Tables 8-2-1 and 8-2-2 (DAA=days after first application; ROC=reduction over control).

Formulations with Tergitol and Atplus were found to provide improved control over cauliflower DBM and aphids.

The exact recipe of Spirotetramat 100+Diafenthiuron 300 SC with Tergitol TMN-6 is as described in table 1-1 form A.

The exact recipe of Spirotetramat 100+Diafenthiuron 300 SC with Atplus 245 is as described in table 1-2 form C.

TABLE 8-1
Test details, cauliflower

| Trial details | Trial 1 | Trial 2 |
|---|---|---|
| Variety | White daval | Dhaval |
| Soil type | Clay loamy | Sandy soil |
| Design & plot size | RBD with three | RBD with three |
| | replications, 30 sqm | replications, |
| | | 15 sqm |
| Crop stage at trial | 160 days | 40 days |
| initiation | | |
| Pest infestation | 30 aphides/plant | 15 aphid adults/leaf |
| at trial initiation | 3-4 DBM larva/leaf | 1-2 DBM/leaf |
| Application method & | Foliar spray | Foliar spray |
| Water volume | 500 L/Ha | 900 L/Ha |
| Application equipment | Knapsack sprayer fitted | Knapsack sprayer |
| | with hollow cone nozzle | fitted with hollow |
| | | cone nozzle |

TABLE 8-2-1
Efficacy results, cauliflower DMB (Plutella xylostella)

| | | Dose | Pre | DBM larva count per plant (number/plant) | | | | | | | | | | | |
|---|---|---|---|---|---|---|---|---|---|---|---|---|---|---|---|
| | Treatment | g/Ha | count | 3DAA | | % ROC | 7DAA | | % ROC | 10DAA | | % ROC | 12DAA | | % ROC |
| 1 | Untreated control | 0 | 2.2 | 2.9 | a | 0 | 3.4 | a | 0 | 4.2 | a | 0 | 4.4 | a | 0 |
| 2 | SPT100 + DFN300SC, Tergitol | 90 + 270 | 2.4 | 1.3 | cde | 53 | 0.9 | fg | 75 | 0.8 | g | 82 | 1.0 | g | 76 |
| 3 | SPT100 + DFN300SC, Tergitol | 180 + 540 | 2.1 | 1.3 | de | 55 | 0.7 | g | 80 | 0.7 | g | 82 | 1.0 | g | 77 |
| 4 | SPT150 + DFN450SC | 90 + 270 | 2.4 | 1.7 | bcd | 41 | 1.2 | cde | 64 | 1.0 | fg | 76 | 1.4 | f | 68 |
| 5 | SPT150 + DFN450SC | 180 + 540 | 2.3 | 1.6 | bcd | 43 | 1.1 | def | 67 | 0.9 | fg | 78 | 1.2 | fg | 71 |
| 6 | SPT 15% OD | 90 | 2.3 | 1.6 | bcd | 45 | 1.1 | def | 68 | 0.9 | fg | 78 | 1.4 | f | 68 |
| 7 | DFN 50% WP | 300 | 2.1 | 1.8 | bc | 36 | 1.8 | b | 48 | 2.5 | b | 39 | 2.9 | b | 34 |
| 8 | TRASSID | 37.5 + 300 | 2.2 | 1.0 | e | 66 | 0.2 | h | 95 | 0.2 | h | 95 | 0.5 | h | 89 |

| | | | | |
|---|---|---|---|---|
| CD@5% | 0.51 | 0.34 | 0.28 | 0.31 |

TABLE 8-2-2
Efficacy results, cauliflower aphids (Brevicoryne brassicae)

| | | Dose | Pre | Aphids count per plant (number/plant) | | | | | | | | | | | |
|---|---|---|---|---|---|---|---|---|---|---|---|---|---|---|---|
| | Treatment | g/Ha | count | 3DAA | | % ROC | 7DAA | | % ROC | 10DAA | | % ROC | 12DAA | | % ROC |
| 1 | Untreated control | 0 | 33.8 | 41.7 | a | 0 | 54.5 | a | 0 | 59.6 | a | 0 | 66.9 | a | 0 |
| 2 | SPT100 + DFN300SC, | 90 + 270 | 32.4 | 20.2 | bcd | 51 | 10.9 | cdef | 80 | 12.8 | cd | 78 | 13.4 | fg | 80 |
| | Atplus 245 | | | | | | | | | | | | | | |
| 3 | SPT100 + DFN300SC, | 180 + 540 | 34.0 | 19.8 | bcd | 52 | 10.2 | cdef | 81 | 11.6 | d | 80 | 12.6 | gh | 81 |
| | Atplus 245 | | | | | | | | | | | | | | |
| 4 | SPT100 + DFN300SC, | 90 + 270 | 33.6 | 17.7 | bcd | 58 | 7.6 | fg | 86 | 7.1 | f | 88 | 8.8 | i | 87 |
| | Tergitol | | | | | | | | | | | | | | |
| 5 | SPT100 + DFN300SC, | 180 + 540 | 36.3 | 16.9 | cd | 59 | 6.4 | g | 88 | 6.5 | f | 89 | 8.4 | i | 88 |
| | Tergitol | | | | | | | | | | | | | | |
| 6 | SPT150 + DFN450SC | 90 + 270 | 36.3 | 23.8 | b | 43 | 12.0 | cde | 78 | 12.4 | d | 79 | 17.6 | cde | 74 |
| 7 | SPT150 + DFN450SC | 180 + 540 | 36.2 | 21.9 | bc | 47 | 10.8 | cdef | 80 | 10.6 | de | 82 | 16.2 | de | 76 |
| 8 | SPT 15% OD | 90 | 34.6 | 19.7 | bcd | 53 | 12.5 | cd | 77 | 10.4 | de | 83 | 17.9 | cd | 73 |
| 9 | DFN 50% WP | 300 | 35.3 | 14.9 | d | 64 | 13.7 | bc | 75 | 16.0 | bc | 73 | 22.5 | b | 66 |
| 10 | TRASSID | 37.5 + 300 | 35.7 | 22.5 | bc | 4 | 9.9 | cdef | 82 | 12.5 | d | 79 | 16.9 | cde | 75 |

| | | | | |
|---|---|---|---|---|
| CD@5% | 6.39 | 3.77 | 3.22 | 2.42 |

### Example 5: Eggplants

Efficacy and phytotoxicity against mites were assessed for eggplant plots, as detailed in Table 9-1. Efficacy results are detailed in Table 9-2.

The exact recipe of Spirotetramat 100+Diafenthiuron 300 SC with Tergitol TMN-6 is as described in table 1-1 form A.

The exact recipe of Spirotetramat 100+Diafenthiuron 300 SC with Atplus 245 is as described in table 1-2 form C.

TABLE 9-1
Test details, eggplants

| Trial details | Trial 1 |
|---|---|
| Variety | Bottle brinjal |
| Soil type | Red soil |
| Design & plot size | RBD, 25 sqm |
| Crop stage at trial initiation | 77 days |
| Pest infestation at initiation | 8-10 mites/leaf |
| Application method & | Foliar spray |
| Water volume | 500 L/Ha |
| Application equipment | Knapsack sprayer |

TABLE 9-2
Efficacy results, eggplant mites (Tetranychus urticae)

| | | | Dose | | | | | | | | | | |
|---|---|---|---|---|---|---|---|---|---|---|---|---|---|
| | | Dose | rate | Pre | Mites count per plant (3 leaves/plant) | | | | | | | | |
| | Treatment | g/Ha | ml/Ha | count | 3DAA | | % ROC | 7DAA | | % ROC | 10DAA | | % ROC |
| 1 | Untreated control | 0 | 0 | 26.8 | 32.2 | a | 0 | 38.4 | a | 0 | 43.2 | a | 0 |
| 2 | SPT100 + DFN300SC, | 90 + 270 | 900 | 29.4 | 5.6 | hij | 83 | 4.2 | efg | 89 | 3.8 | ef | 91 |
| | Atplus 245 | | | | | | | | | | | | |
| 3 | SPT100 + DFN300SC, | 180 + 540 | 1800 | 25.6 | 4.4 | ij | 86 | 3.8 | efgh | 90 | 3.0 | efg | 93 |
| | Atplus 245 | | | | | | | | | | | | |
| 4 | SPT100 + DFN300SC, | 90 + 270 | 900 | 26.6 | 3.4 | j | 89 | 1.8 | gh | 95 | 0.8 | gh | 98 |
| | Tergitol | | | | | | | | | | | | |
| 5 | SPT100 + DFN300SC, | 180 + 540 | 1800 | 23.6 | 3.4 | j | 89 | 1.4 | h | 96 | 0.0 | h | 100 |
| | Tergitol | | | | | | | | | | | | |
| 6 | SPT150 + DFN450SC | 90 + 270 | 600 | 27.2 | 10.2 | ef | 68 | 8.6 | d | 78 | 8.0 | d | 81 |
| 7 | SPT150 + DFN450SC | 180 + 540 | 1200 | 27.8 | 10.6 | ef | 67 | 8.8 | d | 77 | 7.8 | d | 82 |
| 8 | SPT 15% OD | 90 | 600 | 28.2 | 14.0 | cd | 57 | 13.6 | c | 65 | 15.8 | c | 63 |
| 9 | DFN 50% WP | 300 | 600 | 28.2 | 17.6 | b | 45 | 19.4 | b | 49 | 25.4 | b | 41 |
| 10 | TRASSID | 37.5 + 300 | 750 | 28.8 | 12.2 | de | 62 | 8.8 | d | 77 | 8.2 | d | 81 |

| | | | |
|---|---|---|---|
| CD@5% | 2.28 | 2.65 | 2.36 |

Formulations with Tergitol TMN-6 and Atplus 245 were found to provide improved efficacy for eggplant mites and whiteflies. Residuality was 7-10 days.

In all of Examples 1-6 above, superior efficacy was obtained for the formulations with the build-in adjuvant, compared to formulations without the adjuvant and/or the commercial products. The built-in formulations having a reduced pesticide application rate (g Ai\Ha) also had better efficacy compared to formulations without the adjuvant.

1. An agrochemical suspension in concentrate form, comprising:
a) at least one ketoenol insecticide;
b) from about 2 wt % to about 20 wt % of at least one adjuvant;
c) at least one steric and/or static stabilizer;
d) at least one rheomodifier; and
e) water.

2. The agrochemical suspension of claim 1, wherein said at least one adjuvant is selected from C8-C16 fatty alcohol alkoxylates.

3. The agrochemical suspension of claim 1 or 2, wherein said adjuvant is selected from linear or branched C8-C10 alcohol ethoxylate, C8-C10 alcohol propoxylate, C9-C11 alcohol ethoxylate, C9-C11 alcohol propoxylate, C12-C15 alcohol ethoxylate, C12-C15 alcohol propoxylate, isodecyl alcohol ethoxylate, isodecyl alcohol propoxylate, isoundecyl alcohol ethoxylate, isoundecyl alcohol propoxylate, isotridecyl alcohol ethoxylate, isotridecyl alcohol propoxylate, and polyethylene glycol trimethylnonyl ether.

4. The agrochemical suspension of any one of claims 1 to 3, wherein:
(a) the steric stabilizer is selected from ethyleneoxide/propyleneoxide copolymers, acrylate/methacrylate copolymers, C10-C14 fatty alcohol ethoxylates and any combination thereof, and/or
(b) the static stabilizer is selected from alcohol sulphates, alcohol sulfonates, alkyl sulphates, aryl sulphates, alkylaryl sulphates, alkyl-ether sulphates, aryl sulphonates, alkyl aryl sulfonates, lignosulfonates, fatty acid sulfonates (e.g. laurylsulfonate), mono-, di- or tristyryl phenol ethoxylate sulphates, taurate (N-methyl oleyl taurate), isethionate (cocoyl isethionate) and combinations thereof.

5. The agrochemical suspension of any one of claims 1 to 4, wherein said steric and/or static stabilizer is present in the suspension in a concentration ranging between about 1 wt % and 9 wt %.

6. The agrochemical suspension of any one of claims 1 to 5, wherein the weight ratio (w/w) of said at least adjuvant to said steric and/or static stabilizer ranges between about 1:5 and about 5:1.

7. The agrochemical suspension of any one of claims 1 to 6, wherein said rheomodifier is selected from magnesium aluminum silicates, magnesium aluminate metasilicate, cellulose ethers (e.g., hydroxyethyl cellulose, methyl cellulose, hydroxypropylmethyl cellulose), polyvinylalcohol, polyquaternium-10, guar gum, hydroxypropyl guar gum, xanthan gum, carrageenan, starch, gelatin, ghatty gum, gum Arabic, pectin, polyvinyl pyrrolidone, pyrrolidone containing copolymers, carboxyvinyl polymers and combinations thereof.

8. The agrochemical suspension of any one of claims 1 to 7, wherein said rheomodifier is present in the suspension in a concentration ranging between about 0.05 wt % and about 1.5 wt %.

9. The agrochemical suspension of any one of claims 1 to 8, comprising up to 50 wt % water.

10. The agrochemical suspension of any one of claims 1 to 9, wherein said at least one ketoenol insecticide is selected from spirotetramat, spidoxamat, spiropidion, spirodiclofen, spiromesifen, and combinations thereof.

11. The agrochemical suspension of claim 10, wherein the at least one ketoenol insecticide is Spirotetramat.

12. The agrochemical suspension of claim 11, wherein said Spirotetramat is cis-Spirotetramat or the cis trans isomer mixtures thereof.

13. The agrochemical suspension of any one of claims 1 to 12, wherein the suspension comprises between about 2 wt % and about 30 wt % of said at least one ketoenol insecticide.

14. The agrochemical suspension of any one of claims 1 to 13, further comprising at least one additional insecticide.

15. The agrochemical suspension of claim 14, wherein said at least one additional insecticide is Diafenthiuron,

16. The agrochemical suspension of claim 14 or 15, wherein the additional insecticide is present in the suspension in a concentration ranging between about 5 wt % and about 50 wt %.

17. The agrochemical suspension of any one of claims 14 to 16, wherein the weight ratio (w/w) of said at least one ketoenol insecticide and said at least one additional insecticide ranges between about 1:1 and 1:5.

18. The agrochemical suspension of any one of claims 1 to 17, further comprising one or more additives selected from defoamers, buffers, solvents, antifreeze agents, colorants, odorants, antioxidants, UV-stabilizers, thickening agents, sticking agents, and dispersants.

19. An agrochemical suspension in concentrate form, comprising:
a) spirotetramat;
b) from about 2 wt % to about 20 wt % of at least one adjuvant;
c) at least one steric and/or static stabilizer;
d) at least one rheomodifier; and
e) water.

20. An agrochemical suspension in concentrate form, comprising:
a) spirotetramat;
b) from about 2 wt % to about 20 wt % of at least one adjuvant, selected from C8-C16 fatty alcohol alkoxylate;
c) at least one steric stabilizer selected from ethyleneoxide/propyleneoxide copolymers, acrylate/methacrylate copolymers, C10-C14 fatty alcohol ethoxylates and any combination thereof; and/or at least one static stabilizer selected from alcohol sulphates, alcohol sulfonates, alkyl sulphates, aryl sulphates, alkylaryl sulphates, alkyl-ether sulphates, aryl sulphonates, alkyl aryl sulfonates, lignosulfonates, fatty acid sulfonates (e.g. laurylsulfonate), mono-, di- or tristyryl phenol ethoxylate sulphates, taurate (N-methyl oleyl taurate), isethionate (cocoyl isethionate), and combinations thereof;
d) at least one rheomodifier; and
e) water.

21. An agrochemical suspension in concentrate form, comprising:
a) spirotetramat and diafenthiuron;
b) from about 2 wt % to about 20 wt % of at least one adjuvant, selected from C8-C16 fatty alcohol alkoxylate;
c) at least one steric stabilizer selected from ethyleneoxide/propyleneoxide copolymers, acrylate/methacrylate copolymers, C10-C14 fatty alcohol ethoxylates and any combination thereof; and/or at least one static stabilizer selected from alcohol sulphates, alcohol sulfonates, alkyl sulphates, aryl sulphates, alkylaryl sulphates, alkyl-ether sulphates, aryl sulphonates, alkyl aryl sulfonates, lignosulfonates, fatty acid sulfonates (e.g. laurylsulfonate), mono-, di- or tristyryl phenol ethoxylate sulphates, taurate (N-methyl oleyl taurate), isethionate (cocoyl isethionate), and combinations thereof; and
d) water.

22. A pesticide composition comprising the agrochemical suspension of any one of claims 1 to 21, and an agriculturally acceptable liquid carrier.

23. The pesticide composition of claim 22, comprising about 100 g/L Spirotetramat.

24. The pesticide composition of claim 23, further comprising about 300 g/L Diafenthiuron.

25. A method of controlling pest population in a plant, the method comprising applying onto the plant and/or the soil surrounding the plant, the suspension of any one of claims 1 to 21 or the composition of any one of claims 22 to 24.

26. A method of protecting plants from insect infestation, the method comprising applying onto the plant and/or the soil surrounding the plant, the suspension of any one of claims 1 to 21 or the composition of any one of claims 22 to 24.

27. A method for controlling and/or preventing animal pests comprising applying an effective amount of the formulation of any one of claims 1 to 21 or the composition of any one of claims 22 to 24, to a location where the animal pest is to be controlled and/or prevented, so as to thereby control and/or prevent the animal pest.
